(19) United States
(12) Patent Application Publication
(10) Pub. No.: US 2007/0267505 A1
(43) Pub. Date: Nov. 22, 2007

(54) Composite interface memory card

(76) Inventor: Chao-Chang Chen, Shulin City (TW)

Correspondence Address: PRO-TECHTOR INTERNATIONAL SERVICES, 20775 NORADA CT., SARATOGA, CA, 95070, US

(21) Appl. No.: 11/480,201

(22) Filed: Jun. 29, 2006

(30) Foreign Application Priority Data
May 16, 2006 (TW) 95208297

(51) Int. Cl. G06K 19/06

(52) U.S. Cl. 235/492

(57) ABSTRACT

A composite interface memory card includes a first end and a second end. The first end of the memory card includes a USB interface with a plurality of contacts for coupling with a USB socket. The second end of the memory card includes a read/write interface with a plurality of contacts. The first end of the memory card has a thickness greater than that of the second end of the memory card. The second end of the memory card has a width larger than two thirds of a width of the first end of the memory card and smaller than one and two thirds times the width of the first end of the memory card. The composite memory card can be inserted into an adaptor so as to be converted into another memory card of another type.

### BACKGROUND OF THE INVENTION

1. Field of the Invention

The present invention relates to a composite interface memory card. More particularly, the present invention relates to a composite interface memory card including a first end with a universal serial bus (USB) interface and a second end with a read/write interface.

2. Description of the Related Art

Computer techniques are growing in an extremely fast speed, particularly in operational functions and speeds. Electronic cards are widely used in computers and electronic dictionaries for expanding memories, network cards, modems, and small computer system interfaces (SCSI) such as high-capacity hard disks, scanners, etc. A typical form of electronic cards for computers is personal computer memory card international association (PCMCIA) card.

Ordinary PCMCIA cards include designs allowing conversion into other interfaces, such as PCMCIA to SCSI, PCMCIA to IDE (integrated drive electronic), etc. Thus, a notebook type computer can use many interface devices for personal computers.

Electronic cards of other forms can be used with personal digital assistants (PDA) and portable electronic dictionaries. Hence, in addition to memory cards of PCMICA type, multi media cards (MMC), compact flash cards (CF), smart media cards (SMC), memory sticks (MS), and secure digital memory cards (SD) are available on the market for replacement purposes.

However, every memory card has an interface of a specific specification and thus cannot be used with the connection interface of widely used USB (universal serial bus) specification. FIG. 1 of the drawings illustrates a dual-interface memory card 90 including a USB interface 91 on an end thereof for coupling with a USB socket 93 of an electronic device 92. An SD interface 94 is provided on the other end of the memory card 90 for coupling with a card connector. However, the overall length and the overall width of the dual-interface memory card 90 are larger than those of the USB interface 91 such that most part of the dual-interface memory card 90 is exposed outside the USB socket 93 and thus occupies the space required for connection of other connection ports and even interferes with insertion of other cards. Further, the dual-interface memory card 90 is liable to be impacted and thus damaged, resulting in problems to the user. Further, the SD interface 94 of the dual-interface memory card 90 cannot be used with an adaptor for specification conversion.

FIGS. 2 and 3 illustrate an ordinary MS Duo memory card 95 that can only be used with an adaptor 96 for conversion into a memory card with MS specification. FIGS. 4 and 5 illustrate a Mini SD memory card 97 that can only be used with an adaptor 98 for conversion into a memory card with SD specification. Improvement is thus required.

### SUMMARY OF THE INVENTION

In accordance with an aspect of the present invention, a composite interface memory card comprises a first end and a second end. The first end of the memory card includes a USB interface with a plurality of contacts for coupling with a USB socket. The second end of the memory card includes a read/write interface with a plurality of contacts. The first end of the memory card has a thickness greater than that of the second end of the memory card. The second end of the memory card has a width larger than two thirds (⅔) of a width of the first end of the memory card and smaller than one and two thirds ( 5/3) times the width of the first end of the memory card.

In an example, the USB interface and the read/write interface of the memory card are provided on the same side of the memory card.

In another example, the USB interface and the read/write interface of the memory card are provided on different sides of the memory card.

In accordance with another aspect of the present invention, the composite interface memory card is inserted into an adaptor and thus converted into a memory card of another type.

Preferably, the adaptor has an outline the same as that of the memory card of another type. The adaptor includes a first end and a second end. An opening extends from the first end of the adaptor toward the second end of the adaptor, forming an insertion groove for receiving the composite interface memory card. A plurality of resilient conductive plates are provided on a rear end of the insertion groove for respective electrical connection with the contacts of the read/write interface of the composite interface memory card. A plurality of contacts are provided on a bottom face of the second end of the adaptor and match contacts of a read/write interface of the memory card of another type. The contacts on the second end of the adaptor are respectively in electrical connection with the resilient conductive plates.

When the second end of the composite interface memory card is inserted into the insertion groove of the adaptor, the contacts of the read/write interface of the composite interface memory card are electrically connected via the resilient conductive plates to the contacts of the adaptor.

Preferably, an overall width of the resilient conductive plates is smaller than that of the contacts of the adaptor. Each resilient conductive plate includes a first end with a protruding contact portion for contacting with an associated contact of the read/write interface of the composite interface memory card. Each resilient conductive plate further includes a second end in electrical connection with an associated contact of the adaptor.

The composite interface memory card may be converted into a memory card of a secure digital memory card type, a memory stick type, or other type.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of an electronic device and a conventional dual-interface memory card.

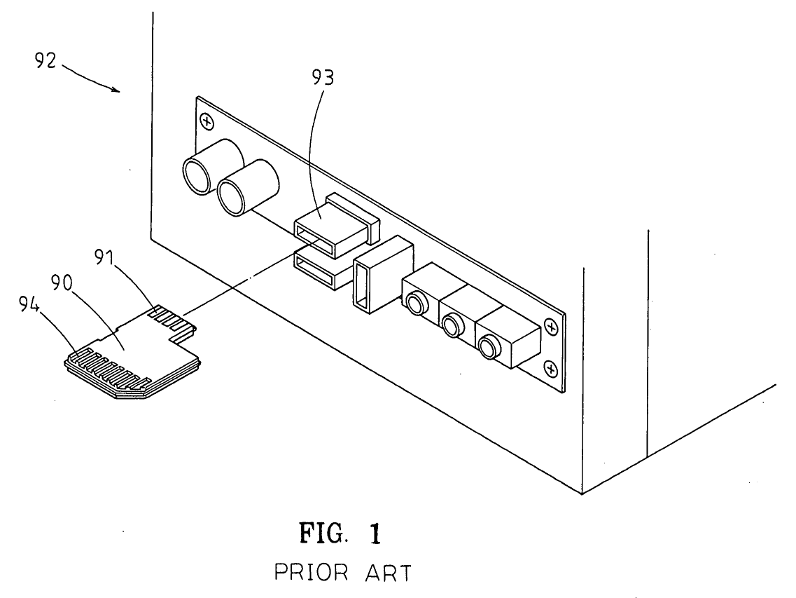

FIG. 2 is an exploded perspective view of a MS Duo memory card and an adaptor.

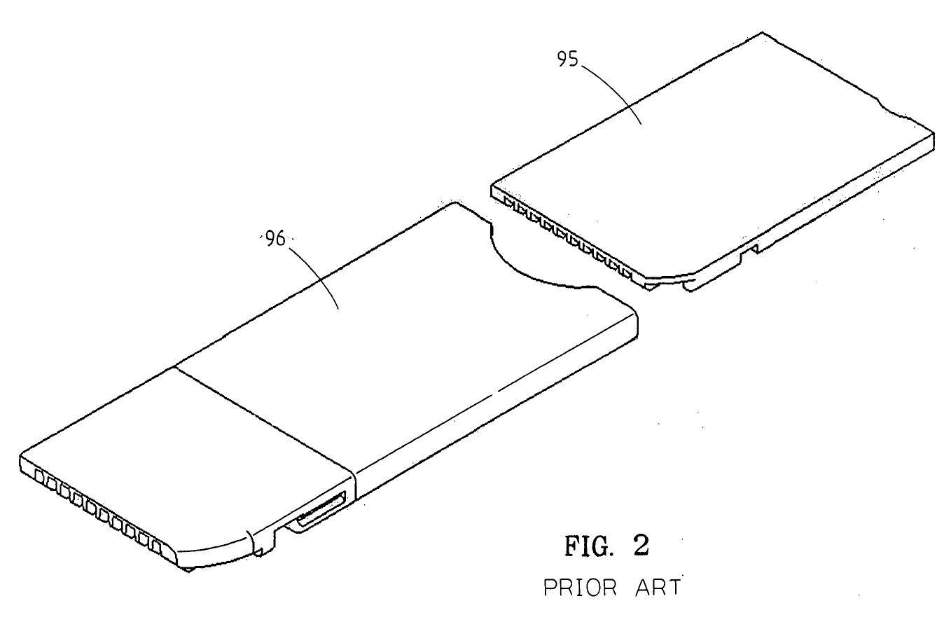

FIG. 3 is a perspective view of the MS Duo memory card and the adaptor in FIG. 2 after assembly.

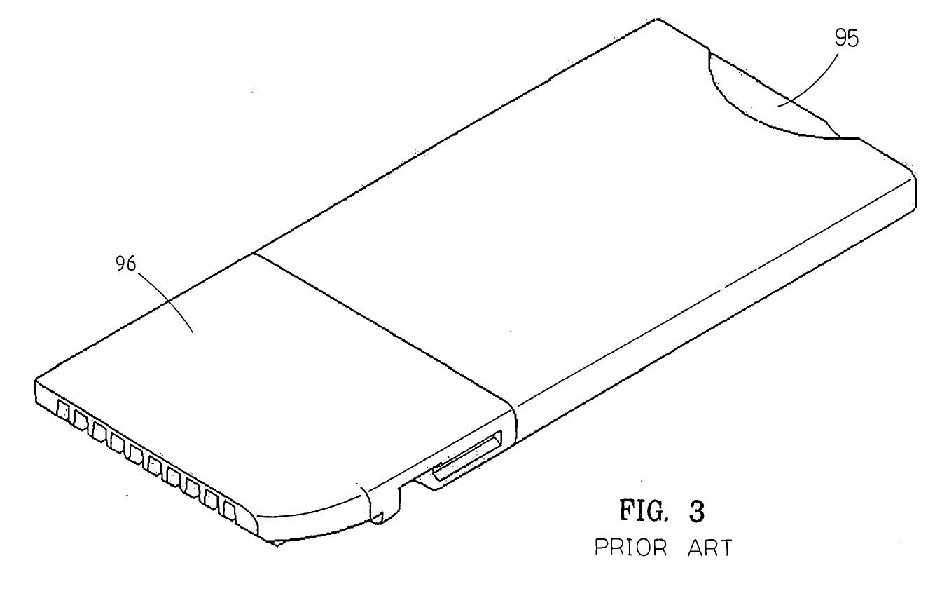

FIG. 4 is an exploded perspective view of a Mini SD memory card and an adaptor.

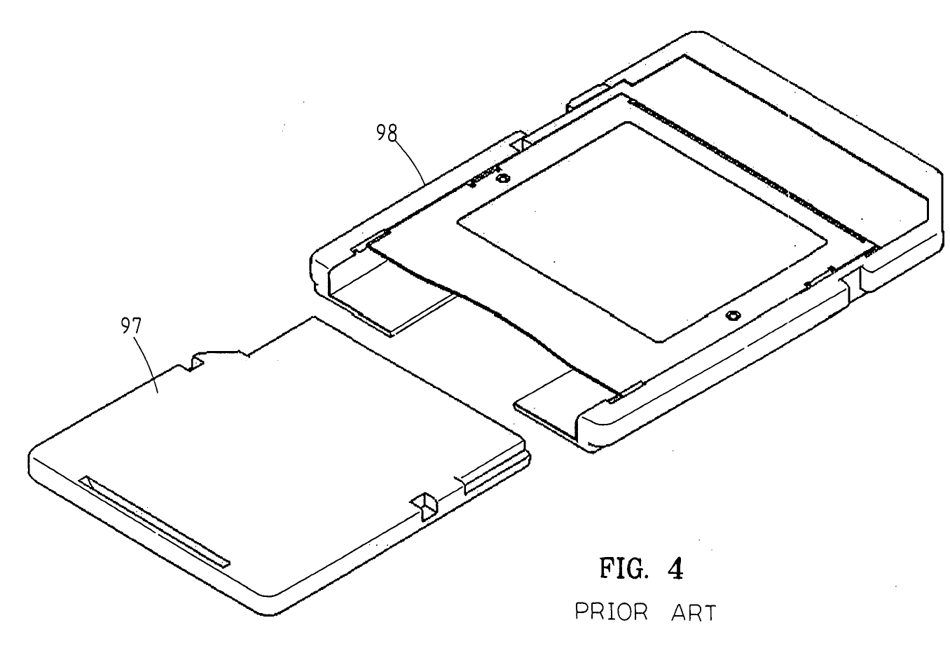

FIG. 5 is a perspective view of the Mini SD memory card and the adaptor in FIG. 4 after assembly.

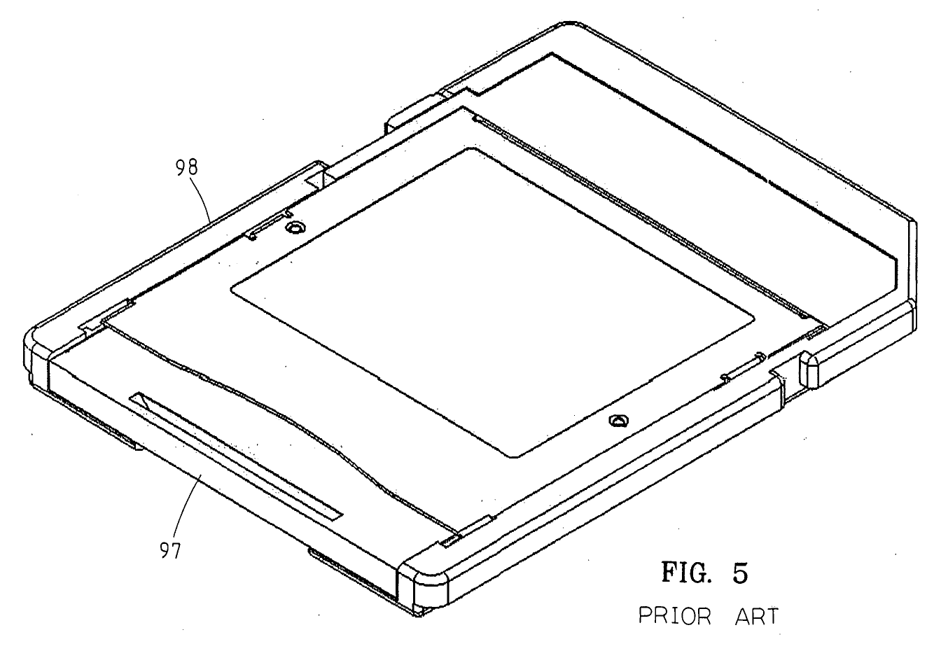

FIG. 6 is a top perspective view of a memory card in accordance with the present invention.

FIG. 7 is a bottom perspective view of the memory card in accordance with the present invention.

FIG. 8 is a perspective view illustrating another example of the memory card in accordance with the present invention.

FIG. 9 is a perspective view illustrating a further example of the memory card in accordance with the present invention.

FIG. 10 is a perspective view illustrating still another example of the memory card in accordance with the present invention.

FIG. 11 is a perspective view illustrating use of the memory card in accordance with the present invention with an adaptor.

FIG. 12 is a bottom perspective view of the memory card and the adaptor in FIG. 11.

FIG. 13 is a perspective view similar to FIG. 11, wherein a top cover is removed from the adaptor.

FIG. 14 is a perspective view of the adaptor in FIG. 13.

FIG. 15 is an exploded perspective view illustrating use of the memory card in accordance with the present invention with another adaptor.

FIG. 16 is a perspective view of the memory card and the adaptor in FIG. 15 after assembly.

### DETAILED DESCRIPTION OF THE PREFERRED EMBODIMENTS

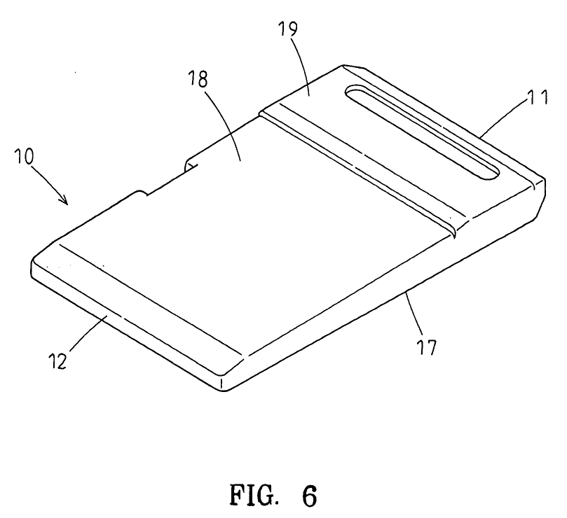

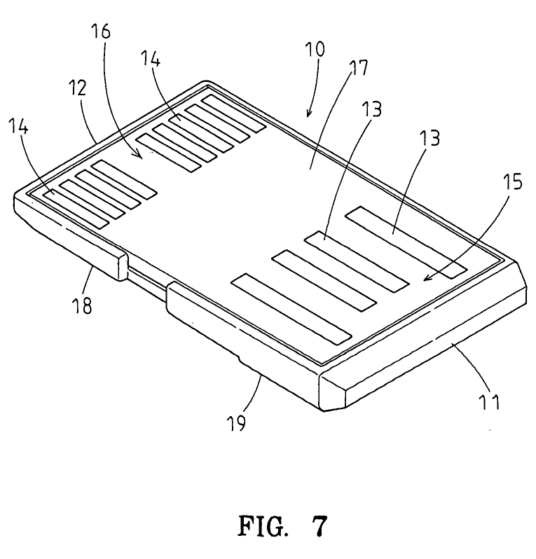

Referring to FIGS. 6 and 7, a memory card 10 in accordance with the present invention is substantially rectangular in section and comprises a plurality of memories and chips. The memory card 10 includes a first end 11 and a second end 12. In this example, the width of the first end 11 is substantially the same as that of the second end 12. The first end 11 of the memory card 10 is configured to match a USB socket. Referring to FIG. 7, a plurality of plate-like contacts 13 are provided on a bottom face 17 of the memory card 10 and adjacent to the first end 11. The contacts 13 match a USB socket interface (not shown) and thus form a USB interface 15. The outline of the first end 11 of the memory card 10 matches a coupling opening of the USB socket to allow insertion for access of information. When the first end 11 of the memory card 10 is inserted into and thus coupled with the USB socket, the second end 12 of the memory card 10 is exposed outside. Nevertheless, the volume, length, and width of the exposed second end 12 are much smaller than those of conventional dual-interface memory cards. This avoids occupation of the space for other connection ports, allowing easy insertion of other memory cards and reducing the risk of damage due to external impact.

The thickness of the first end 11 of the memory card 10 is larger than that of the second end 12 of the memory card 10. Further, a plurality of plate-like contacts 14 are provided on the bottom face 17 of the memory card 10 and adjacent to the second end 12. The contacts 14 form a read/write interface 16. Preferably, there are more than six contacts 14 to include at least a positive pole, a negative pole, and four data poles. The second end 12 and the read/write interface 16 of the memory card 10 allow coupling with a card connector (not shown) of a corresponding specification.

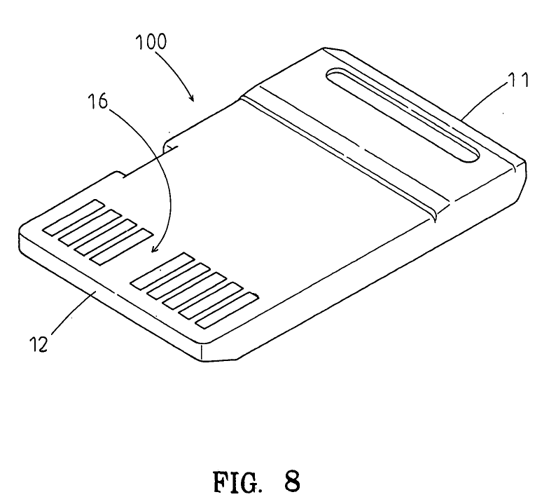

The memory card 10 shown in FIGS. 6 and 7 includes a top face 18 that has an inclined face (not labeled) extending from the second end 12 and contiguous to a stepped section 19 adjacent to the first end 11. Further, the contacts 13 of the USB interface 15 and the contacts 14 of the read/write interface 16 are provided on the bottom face 17. Alternatively, the USB interface 15 and the read/write interface 16 are provided on different sides of the memory card 10. In another example shown in FIG. 8, the read/write interface 16 is provided on the top side of the memory card 100.

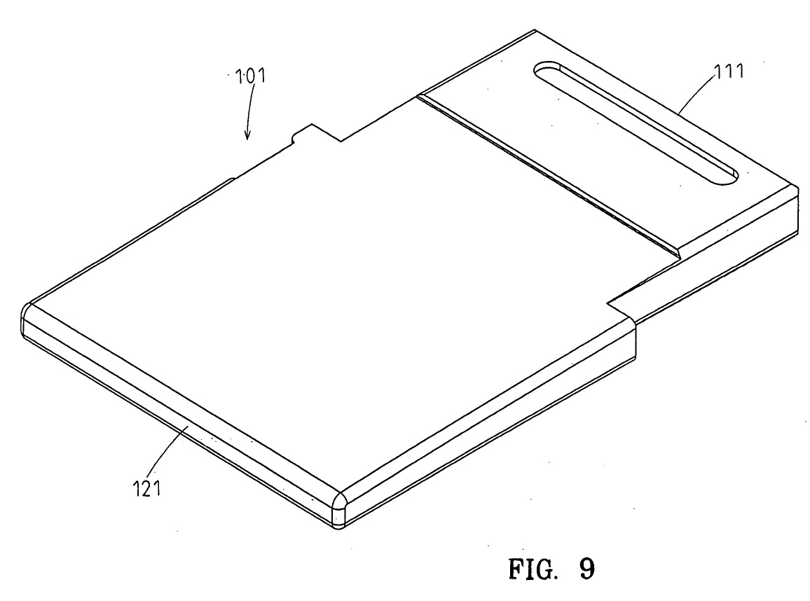

In a further example shown in FIG. 9, the width of the second end 121 of the memory card 101 is larger than that of the first end 111 of the memory card 101 and smaller than one and two thirds ( 5/3) times the width of the first end 111 of the memory card 101.

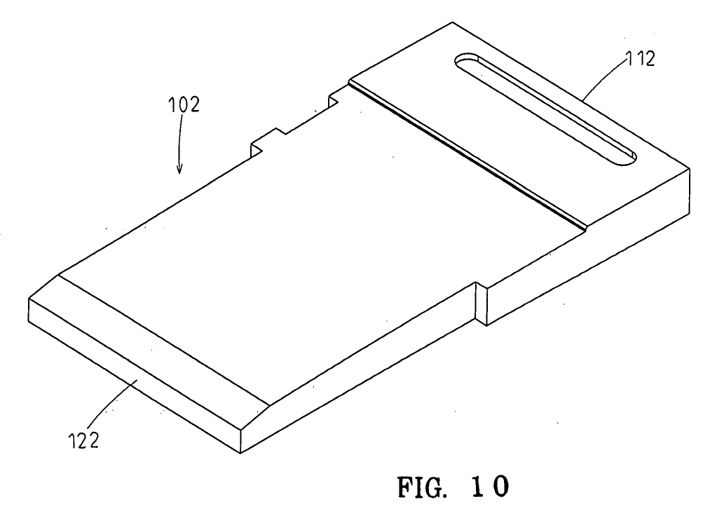

In still another example shown in FIG. 10, the width of the second end 122 of the memory card 102 is smaller than that of the first end 112 of the memory card 102 and larger than two thirds (⅔) of the width of the first end 112 of the memory card 102.

The width of each of the second ends 12, 121, and 122 of the memory card 10, 101, and 102 respectively shown in FIGS. 6, 9, and 10 may be different from those of the specifications of currently available memory cards and thus can be used with a card connector (not shown) of a corresponding specification.

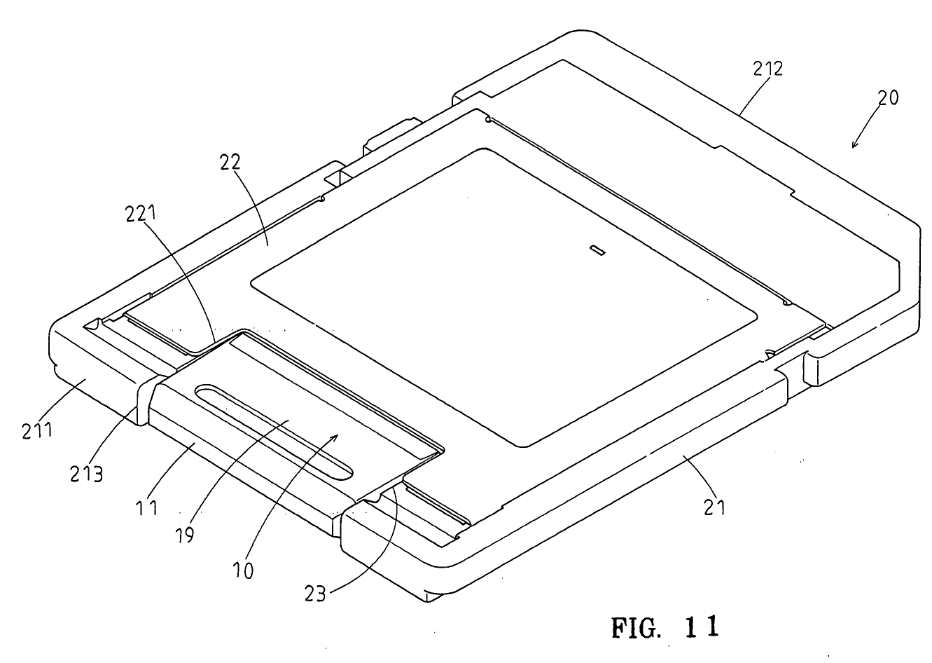

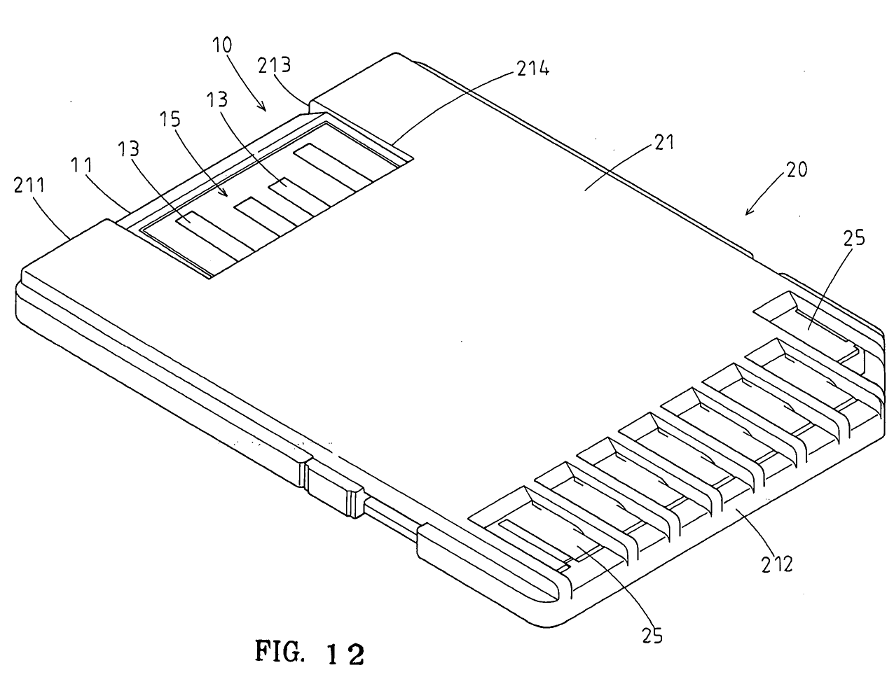

In yet another example shown in FIGS. 11 and 12, the memory card 10 is inserted into an adaptor 20 to provide a memory card of another type and of another interface specification for coupling with a currently available card connector of an ordinary electronic device.

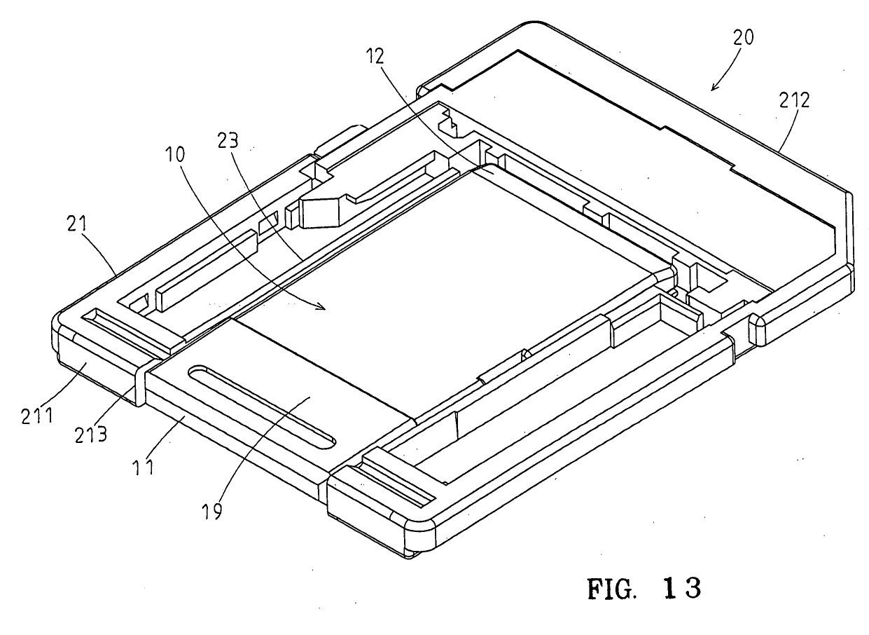

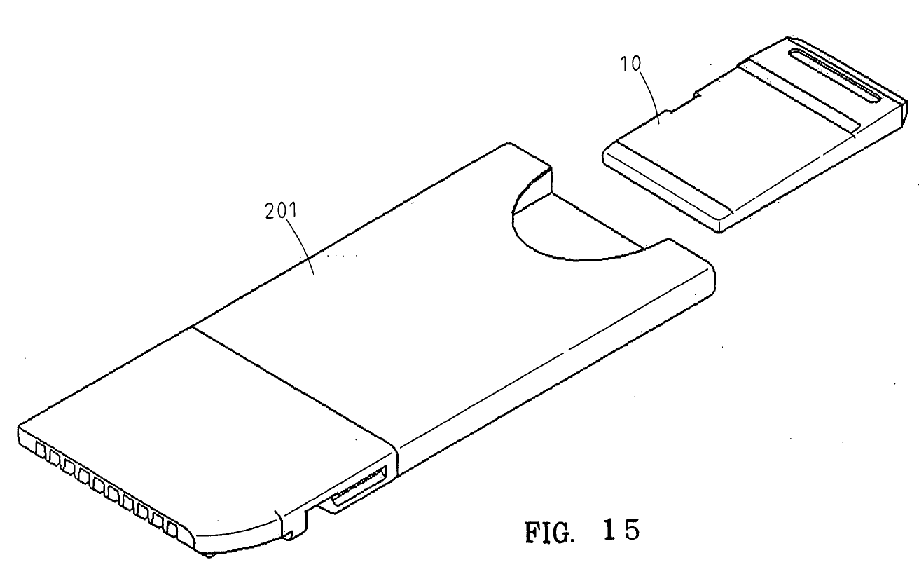

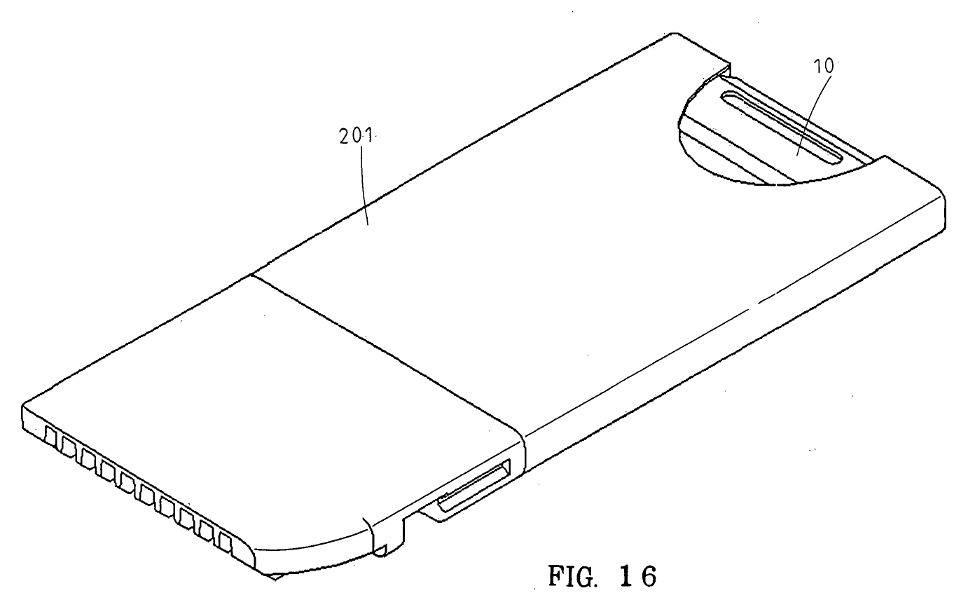

In the adaptor 20 shown in FIGS. 11 through 14, the specification (e.g., the length, width, and thickness) of the adaptor 20 is identical to that of another memory card. The adaptor 20 includes a first end 211 and a second end 212. An opening 213 extends from an intermediate portion of the first end 211 toward the second end 212 of the adaptor 20 to form an insertion groove 23 for receiving the memory card 10. A plurality of resilient conductive plates 24 are provided in a rear end of the insertion groove 23 for respective electrical connection with the contacts 14 (see FIG. 7) of the read/write interface 16 of the memory card 10. Further, a plurality of contacts 25 (see FIG. 12) are provided on a bottom face of the second end 212 of the adaptor 20 and match those of the read/write interface of another memory card of the same specification. The contacts 25 are respectively and electrically connected to the resilient conductive plates 24. The adaptor 20 may be of SD memory card type of an ordinary memory card specification or of other memory card types. In another example shown in FIGS. 15 and 16, the memory card 10 is used with an MS adaptor 20 to form an MS type memory card.

When the memory card 10 is used with an adaptor 20, as illustrated in FIGS. 7 and 11-14, the second end 12 of the memory card 10 is inserted into the insertion groove 23 of the adaptor 20. The contacts 14 of the read/write interface 16 of the memory card 10 are electrically connected to the contacts 25 via the contacts 24 of the adaptor 20, allowing conversion into an interface of another memory card specification (such as the SD memory card in the figures) for coupling with an SD card connector of an ordinary electronic device.

Preferably, the adaptor 20 includes a plastic body 21 and a metal top cover 22 between which the insertion groove 23 is defined. Further, two recessions 214 and 221 are respectively defined in an intermediate portion of the first end 211 of the adaptor 20 and an intermediate portion of the top cover 22 for cooperating with the stepped section 19 of the memory card 10, allowing easy insertion/removal of the memory card 10.

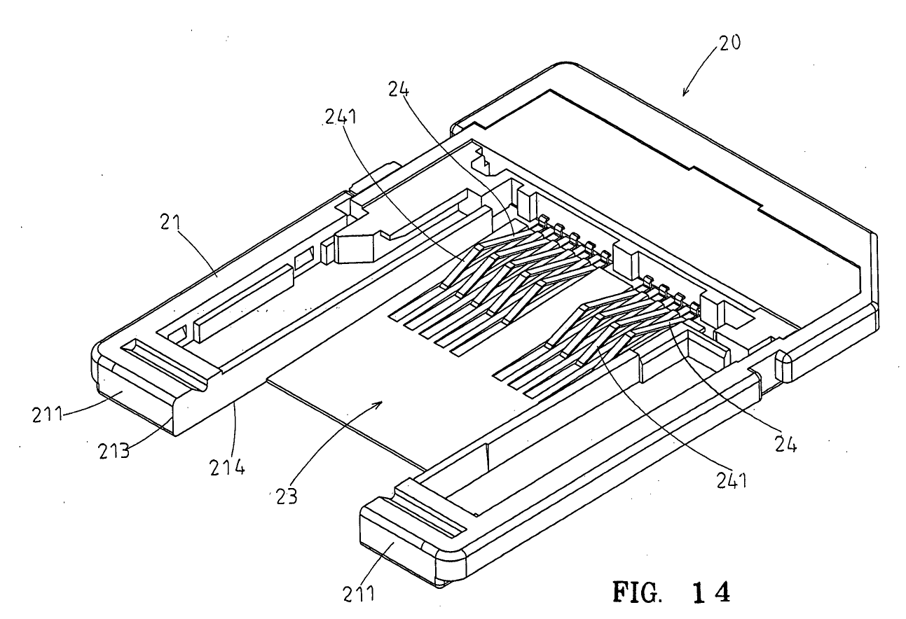

In the adaptor 20 shown in FIGS. 12 and 14, an overall width of the resilient conductive plates 24 is smaller than that of the contacts 25. Each resilient conductive plate 24 includes an end with a protruding contact portion 241 for contacting with an associated contact 14 (see FIG. 7) of the read/write interface 16 of the memory card 10. Further, the other end of each resilient conductive plate 24 is in electrical connection with an associated contact 25 of the adaptor 20, allowing conversion into a memory card of another type with another interface specification.

The length, width, and volume of the exposed portion of the dual-interface memory card in accordance with the present invention are small enough not to occupy the space required for connection of other ports while allowing the USB interface on an end of the dual-interface memory card to be coupled with a USB socket. Further, a read/write interface is provided on the other end of the dual-interface memory card in accordance with the present invention to allow coupling with a card connector of the same interface specification. Further, a desired read/write interface can be selected to form a memory card (such as SD card, MS card, or other memory card) of another specification, allowing reading/writing of data. Multiple usages are provided.

Although specific embodiments have been illustrated and described, numerous modifications and variations are still possible without departing from the essence of the invention. The scope of the invention is limited by the accompanying claims.

What is claimed is:

1. A composite interface memory card comprising a first end and a second end, the first end of the memory card including a USB interface with a plurality of contacts for coupling with a USB socket, the second end of the memory card including a read/write interface with a plurality of contacts, the first end of the memory card having a thickness greater than that of the second end of the memory card, the second end of the memory card having a width larger than two thirds of a width of the first end of the memory card and smaller than one and two thirds times the width of the first end of the memory card.

2. The composite interface memory card as claimed in claim 1 wherein the memory card is rectangular in section and wherein the width of the first end of the memory card is the same as that of the second end of the memory card.

3. The composite interface memory card as claimed in claim 1 wherein the width of the second end of the memory card is greater than the width of the first end of the memory card and smaller than one and two thirds times the width of the first end of the memory card.

4. The composite interface memory card as claimed in claim 1 wherein the width of the second end of the memory card is smaller than the width of the first end of the memory card and greater than two thirds of the width of the first end of the memory card.

5. The composite interface memory card as claimed in claim 1 wherein the USB interface and the read/write interface of the memory card are provided on the same side of the memory card.

6. The composite interface memory card as claimed in claim 1 wherein the USB interface and the read/write interface of the memory card are provided on different sides of the memory card.

7. A combination comprising:
a composite interface memory card comprising a first end and a second end, the first end of the memory card including a USB interface with a plurality of contacts for coupling with a USB socket, the second end of the memory card including a read/write interface with a plurality of contacts, the first end of the memory card having a thickness greater than that of the second end of the memory card, the second end of the memory card having a width larger than two thirds of the width of the first end of the memory card and smaller than one and two thirds times the width of the first end of the memory card; and
an adaptor for removably receiving the composite interface memory card to convert the composite interface memory card into a memory card of another type.

8. The combination as claimed in claim 7 wherein the adaptor has an outline the same as that of said memory card of another type, the adaptor including a first end and a second end, an opening extending from the first end of the adaptor toward the second end of the adaptor, forming an insertion groove for receiving the composite interface memory card, a plurality of resilient conductive plates being provided on a rear end of the insertion groove for respective electrical connection with the contacts of the read/write interface of the composite interface memory card, a plurality of contacts being provided on a bottom face of the second end of the adaptor and matching contacts of a read/write interface of said memory card of another type, the contacts on the second end of the adaptor being respectively in electrical connection with the resilient conductive plates;
wherein when the second end of the composite interface memory card is inserted into the insertion groove of the adaptor, the contacts of the read/write interface of the composite interface memory card are electrically connected via the resilient conductive plates to the contacts of the adaptor.

9. The combination as claimed in claim 8 wherein an overall width of the resilient conductive plates is smaller than that of the contacts of the adaptor, each said resilient conductive plate including a first end with a protruding contact portion for contacting with an associated one of the contacts of the read/write interface of the composite interface memory card, each said resilient conductive plate further including a second end in electrical connection with an associated one of the contacts of the adaptor.

10. The combination as claimed in claim 7 wherein the composite interface memory card is converted into a memory card of a secure digital memory card type or a memory stick type.
